(19) United States
(12) Patent Application Publication
(10) Pub. No.: US 2025/0108794 A1
(43) Pub. Date: Apr. 3, 2025

(54) VEHICLE CONTROL DEVICE, VEHICLE CONTROL METHOD, AND STORAGE MEDIUM

(71) Applicant: HONDA MOTOR CO., LTD., Tokyo (JP)

(72) Inventor: Yoshihiro Oniwa, Tokyo (JP)

(21) Appl. No.: 18/894,424

(22) Filed: Sep. 24, 2024

(30) Foreign Application Priority Data
Sep. 29, 2023 (JP) 2023-169703

(51) Int. Cl. B60W 30/09; B60W 30/095; B60W 40/08; B60W 50/14

(52) U.S. Cl. CPC B60W 30/09; B60W 30/0956; B60W 40/08; B60W 50/14; B60W 2040/0818; B60W 2520/10; B60W 2540/229

(57) ABSTRACT

A vehicle control device of an embodiment includes a recognizer configured to recognize a surrounding situation of a vehicle. a driving state detector configured to detect a driving state of an occupant of the vehicle, and a determiner configured to determine distracted driving of the occupant on the basis of a result of detection by the driving state detector, in which the determiner determines that the occupant is in distracted driving when a steering operation of the occupant is not detected by the driving state detector for a predetermined period of time or more, and the predetermined period of time is set on the basis of a contact margin time between an obstacle near the vehicle and the vehicle, and a speed of the vehicle.

### CROSS-REFERENCE TO RELATED APPLICATION

Priority is claimed on Japanese Patent Application No. 2023-169703, filed Sep. 29, 2023, the content of which is incorporated herein by reference.

### BACKGROUND

### Field of the Invention

The present invention relates to a vehicle control device, a vehicle control method, and a storage medium.

### Description of Related Art

In recent years, there has been an increase in efforts to provide access to sustainable transport systems that take into account the most vulnerable of transport participants. To realize this, people are focusing on research and development to further improve traffic safety and convenience through research and development on preventive safety technology. In relation to this, a technology for detecting distracted driving on the basis of a sight line direction of a driver who drives a vehicle and change data of a steering angle caused by a steering operation of the driver has been conventionally disclosed (for example, Japanese Unexamined Patent Application, First Publication No. 2008-243031).

### SUMMARY

Incidentally, in the preventive safety technology, traveling situations such as a speed of a vehicle and a positional relationship with a preceding vehicle have not been taken into account for determination of distracted driving. For this reason, in the prior art, there have been problems that an appropriate determination of distracted driving is not possible, and appropriate vehicle control cannot be made according to a surrounding situation of the vehicle.

To solve the problems described above, one of the purposes of this application is to provide a vehicle control device, a vehicle control method, and a storage medium that can make a more appropriate determination of distracted driving according to the surrounding situation of a vehicle. This, in turn, contributes to a development of sustainable transportation systems.

The vehicle control device, the vehicle control method, and the storage medium according to the present invention have adopted the following configuration.
(1): A vehicle control device according to one aspect of the present invention includes a recognizer configured to recognize a surrounding situation of a vehicle, a driving state detector configured to detect a driving state of an occupant of the vehicle, and a determiner configured to determine distracted driving of the occupant on the basis of a result of detection by the driving state detector, in which the determiner determines that the occupant is performing distracted driving when a steering operation of the occupant is not detected by the driving state detector for a predetermined period of time or more, and the predetermined period of time is set on the basis of a contact margin time between an obstacle near the vehicle and the vehicle, and a speed of the vehicle.
(2): In the aspect of (1) described above, the predetermined period of time may be set to be longer as the contact margin time increases.
(3): In the aspect of (2) described above, when the contact margin time is equal to or greater than a predetermined value, the predetermined period of time may be set so that an amount of adjustment of time corresponding to the contact margin time is suppressed.
(4): In the aspect of (1) described above, the predetermined period of time may be set to be longer as the speed of the vehicle decreases.
(5): In the aspect of (4) described above, when the speed of the vehicle is less than a predetermined speed, the predetermined period of time may be set so that an amount of adjustment of time corresponding to the speed of the vehicle is suppressed.
(6): In the aspect of (1) described above, when there is no driving operation of the occupant, which is set on the basis of the contact margin time, the predetermined period of time may be set by multiplying a reference time at which a vehicle can be determined to be able to travel without contacting the obstacle and a coefficient set on the basis of the speed of the vehicle.
(7): In the aspect of (1) described above, the vehicle control device further includes a vehicle controller configured to control one or both of steering and acceleration or deceleration of the vehicle on the basis of the contact margin time and performs attention calling to the occupant when the determiner determines that the occupant is performing distracted driving.
(8): A vehicle control method according to another aspect of the present invention includes, by a computer, recognizing a surrounding situation of a vehicle, detecting a driving state of an occupant of the vehicle, and determining that the occupant is performing distracted driving when a steering operation of the occupant is not detected for a predetermined period of time or more on the basis of a result of detection, in which the predetermined period of time is set on the basis of a contact margin time between an obstacle near the vehicle and the vehicle, and a speed of the vehicle.
(9): A computer-readable non-temporary storage medium has stored a program causing a computer to execute recognizing a surrounding situation of a vehicle, detecting a driving state of an occupant of the vehicle, and determining that the occupant is performing distracted driving when a steering operation of the occupant is not detected for a predetermined period of time or more on the basis of a result of detection, in which the predetermined period of time is set on the basis of a contact margin time between an obstacle near the vehicle and the vehicle, and a speed of the vehicle.

According to the aspects (1) to (9) described above, it is possible to perform a more appropriate distracted driving determination depending on a surrounding situation of a vehicle.

### BRIEF DESCRIPTION OF THE DRAWINGS

FIG. 1 is a configuration diagram of a vehicle equipped with a vehicle control device according to an embodiment.

FIG. 2 is a diagram for describing content of vehicle control according to the embodiment.

FIG. 3 is a diagram for describing content of attention calling control.

FIG. 4 is a diagram for describing content of contact caution warning control.

FIG. 5 is a diagram for describing content of automatic steering avoidance control.

FIG. 6 is a diagram for describing steering control after a driver steering trigger.

FIG. 7 is a diagram for describing a speed condition of a host vehicle M when control is started for each operation phase.

FIG. 8 is a diagram for describing content of distracted driving determination.

FIG. 9 is a diagram for describing a relationship between contact margin time TTC and continuation determination reference time.

FIG. 10 is a diagram for describing a relationship between a speed of the host vehicle M and a vehicle speed coefficient.

FIG. 11 is a flowchart which shows an example of processing executed by a driving support device in the embodiment.

FIG. 12 is a flowchart which shows an example of distracted determination processing.

### DESCRIPTION OF EMBODIMENTS

Hereinafter, embodiments of a vehicle control device, a vehicle control method, and a storage medium of the present invention will be described with reference to the drawings.

### Overall Configuration

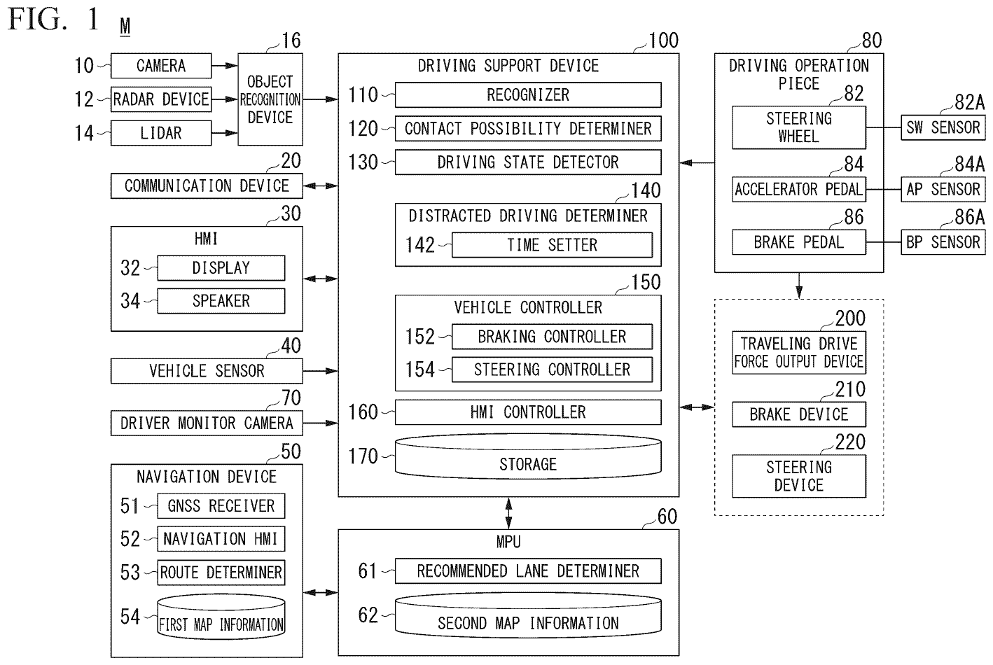

FIG. 1 is a configuration diagram of a vehicle equipped with a vehicle control device according to an embodiment. The vehicle equipped with the vehicle control device (hereinafter referred to as a host vehicle M) is, for example, a two-wheeled vehicle, a three-wheeled vehicle, a four-wheeled vehicle, or the like, and its driving source is an internal combustion engine such as a diesel engine or gasoline engine, an electric motor, or a combination of these. An electric motor operates using power generated by a generator connected to an internal combustion engine or power discharged from a secondary battery or fuel cell.

The host vehicle M is equipped with, for example, a camera 10, a radar device 12, a light detection and ranging (LIDAR) 14, an object recognition device 16, a communication device 20, a human machine interface (HMI) 30, a vehicle sensor 40, a navigation device 50, a map positioning unit (MPU) 60, a driver monitor camera 70, a driving operation piece 80, a driving support device 100, a traveling drive force output device 200, a brake device 210, and a steering device 220. These devices and apparatuses are connected to each other by a multiplex communication line such as a controller area network (CAN) communication line, a serial communication line, a wireless communication network, or the like. The configuration shown in FIG. 1 is merely an example, and a part of the configuration may be omitted or another configuration may be added. The driving support device 100 is an example of a “vehicle control device.”

The camera 10 is a digital camera that uses a solid-state image sensor such as a charge coupled device (CCD) or a complementary metal oxide semiconductor (CMOS). The camera 10 is attached to an arbitrary place in the host vehicle M. For example, when an image of the front of the host vehicle M is captured, the camera 10 is attached to an upper part of the front windshield, a back surface of the windshield rear-view mirror, and the like. The camera 10 periodically and repeatedly captures, for example, a periphery of the host vehicle M. The camera 10 may be a stereo camera.

The radar device 12 radiates radio waves such as millimeter waves to the periphery of the host vehicle M, and also detects at least a position (a distance and an orientation) of an object by detecting radio waves (reflected waves) reflected by the object. The radar device 12 is attached to an arbitrary place on the host vehicle M. The radar device 12 may detect the position and speed of an object in a frequency modulated continuous wave (FM-CW) method.

The LIDAR 14 irradiates the periphery of the host vehicle M with light (or electromagnetic waves with wavelengths close to that of light) and measures scattered light. The LIDAR 14 detects a distance to a target based on a time from light emission to light reception. The irradiated light is, for example, a pulsed laser beam. The LIDAR 14 is attached to an arbitrary place on the host vehicle M.

The object recognition device 16 performs sensor fusion processing on a result of detection by some or all of the camera 10, the radar device 12, and the LIDAR 14, and recognizes the position, type, speed, and the like of an object. The object recognition device 16 outputs a result of recognition to the driving support device 100. The object recognition device 16 may output the results of detection by the camera 10, the radar device 12, and the LIDAR 14 to the driving support device 100 as they are. The object recognition device 16 may be omitted from the host vehicle M. Some or all of the camera 10, the radar device 12, the LIDAR 14, and the object recognition device 16 are examples of “external detection devices.”

The communication device 20 uses, for example, a cellular network, a Wi-Fi network, Bluetooth (registered trademark), dedicated short range communication (DSRC), and the like to communicate with other vehicles present near the host vehicle M, or communicate with various server devices via a wireless base station.

The HMI 30 presents various types of information to an occupant of the host vehicle M, and also receives an input operation from the occupant. The HMI 30 includes, for example, a display 32 and a speaker 34. The display 32 is, for example, a liquid crystal display (LCD), an organic electro luminescence (EL) display device, or the like. The display 32 displays various images (including a video) in the embodiment. The display 32 may be configured integrally with an input as a touch panel. The speaker 34 outputs a predetermined sound (for example, a warning, or the like). In addition to (or in place of) the display 32 and the speaker 34, the HMI 30 may be a microphone, a buzzer, a vibration generator (vibrator), a touch panel, a switch, a key, or the like.

The vehicle sensor 40 includes a vehicle speed sensor that detects a speed of the host vehicle M, an acceleration sensor that detects the acceleration, a yaw rate sensor that detects the yaw rate (for example, a rotational angular speed around the vertical axis passing through a center of gravity of the host vehicle M), and an azimuth sensor that detects a direction of the host vehicle M. The vehicle sensor 40 may be provided with a position sensor that detects a position of the host vehicle M. The position sensor is, for example, a sensor that acquires position information (longitude and latitude information) from a global positioning system (GPS) device. The position sensor may be a sensor that acquires position information using a global navigation satellite system (GNSS) receiver 51 of the navigation device 50.

The navigation device 50 includes, for example, a GNSS receiver 51, a navigation HMI 52, and a route determiner 53. The navigation device 50 holds first map information 54 in a storage device such as a hard disk drive (HDD) or a flash memory. The GNSS receiver 51 identifies the position of the host vehicle M based on a signal received from a GNSS satellite. The position of the host vehicle M may be identified or complemented by an inertial navigation system (INS) using an output of the vehicle sensor 40. The navigation HMI 52 includes a display device, a speaker, a touch panel, a key, and the like. The navigation HMI 52 may be partially or entirely shared with the HMI 30 described above. The route determiner 53 determines, for example, a route from the position of the host vehicle M (or an arbitrary position to be input) identified by the GNSS receiver 51 to a destination to be input by the occupant using the navigation HMI 52 (hereinafter, a route on a map) with reference to the first map information 54. The first map information 54 is, for example, information in which a road shape is expressed by a link indicating a road and nodes connected by a link. The first map information 54 may include a road curvature, point of interest (POI) information, and the like. A route on a map is output to the MPU 60. The navigation device 50 may perform route guidance using the navigation HMI 52 based on the route on a map. The navigation device 50 may be realized by, for example, a function of a terminal device such as a smartphone or a tablet terminal owned by the occupant. The navigation device 50 may transmit a current position and a destination to a navigation server via the communication device 20 and acquire a route equivalent to the route on a map from the navigation server.

The MPU 60 includes, for example, a recommended lane determiner 61, and holds second map information 62 in a storage device such as an HDD or a flash memory. The recommended lane determiner 61 divides the route on a map provided from the navigation device 50 into a plurality of blocks (for example, divides every 100 [m] in a vehicle traveling direction), and determines a recommended lane for each block with reference to the second map information 62. The recommended lane determiner 61 determines which numbered lane from the left to drive. When a branch place is present on the route on a map, the recommended lane determiner 61 determines a recommended lane so that the host vehicle M can travel on a reasonable route to proceed to the branch destination. The second map information 62 is map information with higher accuracy than the first map information 54. The second map information 62 includes, for example, information on a center of a lane, information on a boundary of the lane such as road division lines that divide a lane, and the like. The second map information 62 may include road information, traffic regulation information, address information (addresses/zip codes), facility information, telephone number information, and the like. The second map information 62 may be updated at any time by the communication device 20 communicating with another device. The first map information 54 and the second map information 62 may be stored in a storage of the driving support device 100.

The driver monitor camera 70 is, for example, a digital camera using a solid-state imaging device such as CCD or CMOS. For example, the driver monitor camera 70 is attached at any place on the host vehicle M, which is a position and a direction at which the head and upper body (including a position of the hands) of an occupant (hereafter referred to as a driver) seated in a driver's seat of the host vehicle M can be imaged from the front (in a direction for imaging the face). For example, the driver monitor camera 70 is attached to an upper portion of a display device provided in a center portion of an instrument panel of the host vehicle M. Therefore, since the image captured by the driver monitor camera 70 includes the driver and a steering wheel 82, it can also be determined from the image whether the driver is gripping the steering wheel 82. The driver monitor camera 70 outputs to the driving support device 100 a captured image of a vehicle compartment of the host vehicle M including the driver from a position where it is placed.

The driving operation piece 80 includes, for example, the steering wheel 82, an accelerator pedal 84, a brake pedal 86, an operation switch of direction indicator, a shift lever, and other operators. The driving operation piece 80 has a sensor that detects an amount of operation or a presence or absence of an operation attached thereto, and a result of detection is output to the driving support device 100, or some or all of the traveling drive force output device 200, the brake device 210, and the steering device 220.

For example, the steering wheel 82 is provided with a steering wheel sensor (SW sensor) 82A. The SW sensor 82A detects whether the driver is gripping the steering wheel 82 using a contact sensor, a pressure sensor, or the like. The SW sensor 82A detects an operation amount of the steering wheel 82 (steering torque (input steering torque), an amount of steering) input (operated) by the driver. The SW sensor 82A may detect an operation change rate (a torque change rate). The steering wheel 82 does not necessarily have to be annular, and may be in a form of a deformed steering wheel, a joystick, a button, or the like. In that case, the SW sensor 82A detects the amount of operation according to each form.

An accelerator pedal sensor (AP sensor) 84A is attached to the accelerator pedal 84. The AP sensor 84A detects an operation amount (an opening degree) of the accelerator pedal 84, which changes according to an operation of the driver with respect to the accelerator pedal 84. The brake pedal 86 is provided with a brake pedal sensor (BP sensor) 86A. The BP sensor 86A detects an operation amount (an opening degree) of the brake pedal 86, which changes according to an operation of the driver with respect to the brake pedal 86.

The traveling drive force output device 200 outputs traveling drive force (torque) for the host vehicle M to travel to the driving wheels. The traveling drive force output device 200 includes, for example, a combination of an internal combustion engine, an electric motor, a transmission, and the like, and an electronic control unit (ECU) that controls these. The ECU controls the constituents described above according to information input from the driving support device 100 or information input from the driving operation piece 80.

The brake device 210 includes, for example, a brake caliper, a cylinder that transmits a hydraulic pressure to the brake caliper, an electric motor that generates a hydraulic pressure in the cylinder, and an ECU. The ECU controls the electric motor according to the information input from the driving support device 100 or the information input from the driving operation piece 80 so that a brake torque corresponding to a braking operation is output to each wheel. The brake device 210 may include a mechanism for transmitting the hydraulic pressure generated by operating a brake pedal included in the driving operation piece 80 to the cylinder via a master cylinder as a backup mechanism. The brake device 210 is not limited to the configuration described above, and may be an electronically controlled hydraulic brake device that controls an actuator according to the information input from the driving support device 100 and transmits the hydraulic pressure of the master cylinder to the cylinder.

The steering device 220 includes, for example, a steering ECU and an electric motor. For example, the electric motor applies force to a rack and pinion mechanism to change a direction of a steered wheel. The steering ECU drives the electric motor according to the information input from the driving support device 100 or the information input from the driving operation piece 80 to change the direction of the steered wheel.

### Driving Support Device

The driving support device 100 includes, for example, a recognizer 110, a contact possibility determiner 120, a driving state detector 130, a distracted driving determiner 140, a vehicle controller 150, an HMI controller 160, and a storage 170. The recognizer 110, the contact possibility determiner 120, the driving state detector 130, the distracted driving determiner 140, the vehicle controller 150, and the HMI controller 160 are realized by, for example, a hardware processor such as a central processing unit (CPU) executing a program (software). Some or all of these components may be realized by hardware (a circuit unit; including circuitry) such as large scale integration (LSI), an application specific integrated circuit (ASIC), a field-programmable gate array (FPGA), and a graphics processing unit (GPU), or may also be realized by software and hardware in cooperation. The program may be stored in advance in a storage device such as an HDD or flash memory of the driving support device 100 (a storage device equipped with a non-transitory storage medium), or may be stored in a removable storage medium such as a DVD or CD-ROM and installed in the HDD or flash memory of the driving support device 100 by attaching the storage medium (non-transitory storage medium) to a drive device. The distracted driving determiner 140 is an example of a “determiner.” The HMI controller 160 is an example of a “notification controller.”

For example, settings are made within the traveling drive force output device 200, the brake device 210, and the steering device 220 so that instructions from the driving support device 100 to the traveling drive force output device 200, the brake device 210, and the steering device 220 are executed with priority over a result of detection from the driving operation piece 80. Regarding braking, when a braking force based on the operation amount of the brake pedal 86 is greater than a braking force based on an instruction from the driving support device 100, the settings may be made so that the latter is preferentially executed. Communication priority in an in-vehicle local area network (LAN) may be used as a mechanism for preferentially executing an instruction from the driving support device 100. Regarding steering, it may be set to be executed by adding a steering force based on the instruction from the driving support device 100 and a steering force based on the operation amount of the steering wheel 82 of the driver.

The storage 170 may be realized by various storage devices described above, or a solid state drive (SSD), an electrically erasable programmable read only memory (EEPROM), a read only memory (ROM), a random access memory (RAM), or the like. The storage 170 stores, for example, a program, information used by components within the driving support device 100, and other various types of information. The map information (first map information 54, second map information 62) described above may be stored in the storage 170.

The recognizer 110 recognizes a surrounding situation of the host vehicle M on the basis of information input from an external detection device. For example, the recognizer 110 recognizes states of an object present in the surrounding (for example, within a predetermined distance from the host vehicle M) such as a position (a relative position, an inter-vehicle distance), a speed (a relative speed), and an acceleration. Examples of an object include another vehicle, a bicycle, a pedestrian. The position of an object is recognized, for example, as a position on absolute coordinates with a representative point (a center of gravity, a drive shaft center, or the like) of the host vehicle M as the origin, and used for control. The position of an object may be expressed by a representative point such as the center of gravity or a corner of the object, or may be expressed by an area. The “states” of an object may include the acceleration or jerk of the object, or a “behavioral state” (for example, whether it is changing lanes or is about to change lanes). The recognizer 110 recognizes a relative position and a relative speed with respect to an object.

The recognizer 110 recognizes, for example, a lane (a traveling lane) in which the host vehicle M is traveling. For example, the recognizer 110 recognizes a traveling lane by comparing a pattern of road division line (for example, an array of solid lines and broken lines) obtained from the second map information 62 with a pattern of road division line in the periphery of the host vehicle M recognized from an image captured by the camera 10. The recognizer 110 may also recognize a traveling lane by recognizing not only the road division line but also road boundaries including the road division line, a road shoulder, a curb, a median strip, a guardrail, and the like. In this recognition, the position of the host vehicle M acquired from the navigation device 50 and a result of processing by the INS may be taken into account. The recognizer 110 recognizes obstacles, stop lines, red lights, tollhouses, and other road events from results of the recognition of an object. The obstacle is an object with which the host vehicle M needs to avoid contact, and includes, for example, another vehicle, and the like.

The recognizer 110 recognizes the position and posture of the host vehicle M with respect to a traveling lane when a traveling lane is recognized. The recognizer 110 may recognize, for example, a deviation of a reference point of the host vehicle M from a center of the lane and an angle of the host vehicle M, formed with respect to a line connecting the centers of the lane in the traveling direction, as a relative position and the posture of the host vehicle M with respect to the traveling lane. Instead, the recognizer 110 may recognize the position or the like of the reference point of the host vehicle M with respect to any side end (a road division line or road boundary) of the traveling lane as the relative position of the host vehicle M with respect to the traveling lane.

The contact possibility determiner 120 determines whether there is a possibility that an obstacle (for example, other vehicle) and the host vehicle M will come into contact, on the basis of the surrounding situation (external world information) recognized by the recognizer 110. For example, the contact possibility determiner 120 determines whether there is a possibility that the host vehicle M will come into contact with another vehicle (a preceding vehicle) present in front of the host vehicle M on the basis of a contact margin value with the other vehicle on the basis of the surrounding situation. The contact margin value is, for example, a value set on the basis of a contact margin time TTC (time to collision), but may also be a value set on the basis of an inter-vehicle time THW (time headway). The contact margin time TTC is derived, for example, by dividing a relative distance by a relative speed in a relationship between the host vehicle M and the other vehicle. The inter-vehicle time THW is derived by, for example, dividing the relative distance (the inter-vehicle distance) by the speed of the host vehicle M. The contact margin time TTC may be derived by using, for example, a trained model that outputs the contact margin time TTC, a predetermined function, or the like when positions and speeds of the host vehicle M and other vehicles are input, and may also be derived by using a correspondence table in which the relative speeds, relative positions, and contact margin time TTC are associated with each other. The derivation method described above is the same for the inter-vehicle time THW. For example, as the contact margin time TTC (or inter-vehicle time THW) decreases, the contact margin value becomes smaller (in other words, the contact margin time increases, the contact margin value becomes larger. For example, the contact possibility determiner 120 determines that there is a possibility of contact between the host vehicle M and another vehicle when the contact margin value is less than a threshold value, and determines that there is no possibility of contact when the contact margin value is equal to or greater than the threshold value.

The driving state detector 130 detects a driving state of the occupant (driver) of the host vehicle M. The driving state is, for example, a gripping or steering operation (a steering torque or a steering amount) of the steering wheel 82. In addition to (or in place of) the description above, the driving state may also be at least one of an accelerator operation or operation amount (an opening degree) by the accelerator pedal 84 and a brake operation or operation amount (an opening degree) by the brake pedal 86. The driving state is acquired on the basis of, for example, results of detection by the SW sensor 82A, the AP sensor 84A, and the BP sensor 86A. The driving state detector 130 may detect a state in which the driver is not performing a driving operation (for example, at least one of a steering operation, an accelerator operation, and a brake operation) on the basis of a result of the detection by each sensor.

The driving state detector 130 may detect that a state of the driver is not suitable for driving on the basis of an analysis result of an image captured by the driver monitor camera 70. For example, the driving state detector 130 detects that the state of the driver is not suitable for driving when the driver does not monitor the surroundings (especially the front) of the host vehicle M by looking away based on the analysis result of the image, or when it is predicted that concentration is decreasing based on a predetermined facial expression (a drowsy face or a painful face).

The distracted driving determiner 140 determines distracted driving of the driver on the basis of a detection result of the driving state detector 130. Distracted driving is, for example, driving in a state in which a driving operation of the host vehicle M becomes slow (or does not operate) due to a decrease in attentiveness of the driver or the like. For example, the driving state detector 130 determines that the driver is performing distracted driving when a state in which a steering operation of the steering wheel 82 by the driver is less than a threshold value (a determination threshold value TH1 to be described below) continues for a predetermined period of time (a first predetermined period of time) or more based on a result of detection by the SW sensor 82A, and determines that the driver is not performing the distracted driving when the state does not continue for a predetermined period of time or more.

In place of (or in addition to) a steering operation of the driver, the distracted driving determiner 140 may detect that the driver is performing the distracted driving when a state in which amounts of change in opening degrees of the accelerator pedal 84 and the brake pedal 86 are less than a threshold value continues for a predetermined period of time (a second predetermined period of time) or more based on the results of detection by the AP sensor 84A and the BP sensor 86A. In place of (or in addition to) the determination described above, the distracted driving determiner 140 may determines that the driver is performing the distracted driving when a state in which the driving state detector 130 has detected that the state of the driver is not suitable for driving continues for a predetermined period of time (a third predetermined period of time) or more, and may also determine that the driver is not performing the distracted driving when the state does not continue for the predetermined period of time or more. The first predetermined period of time, the second predetermined period of time, and the third predetermined period of time may be the same time or different times.

The distracted driving determiner 140 includes, for example, a time setter 142. The time setter 142 sets the predetermined period of times described above (the first predetermined period of time, the second predetermined period of time, and the third predetermined period of time) according to the surrounding situation of the host vehicle M and the like. For example, the time setter 142 sets a predetermined period of time on the basis of the contact margin time TTC between the host vehicle M and an obstacle (for example, a preceding vehicle) near the host vehicle M, and the speed of the host vehicle M. Specifically, the time setter 142 sets the predetermined period of time to be shorter as the speed of the host vehicle M increases, or sets the predetermined period of time to be shorter as the contact margin time TTC becomes shorter. As a result, it is possible to determine distracted driving more appropriately on the basis of the situation or the surrounding situation of the host vehicle M based on the speed of the host vehicle M and a positional relationship between the host vehicle M and the obstacle.

The vehicle controller 150 controls one or both of steering and acceleration or deceleration of the host vehicle M on the basis of the surrounding situation recognized by the recognizer 110. Furthermore, the vehicle controller 150 may also control one or both of the steering and acceleration or deceleration of the host vehicle M on the basis of a processing result of at least one of the contact possibility determiner 120, the driving state detector 130, and the distracted driving determiner 140. The vehicle controller 150 includes, for example, a braking controller 152 and a steering controller 154.

On the basis of a recognition result of the recognizer 110, the braking controller 152 performs braking control of the host vehicle M in response to a driving operation by the driver of the host vehicle M (hereinafter referred to as a driver operation) or regardless of the driver operation. For example, the braking controller 152 performs at least deceleration control of the host vehicle M on the basis of a target deceleration of the host vehicle M when it is determined that an obstacle is present in front of the host vehicle M. For example, the braking controller 152 sets a deceleration state on the basis of the contact margin value between the host vehicle M and the obstacle, and executes deceleration control based on the set deceleration state. The braking controller 152 includes, for example, slow deceleration control and contact avoidance braking control.

The braking controller 152 performs slow deceleration control of the host vehicle M when the recognizer 110 determines that an obstacle (for example, another vehicle) is present in front of the host vehicle M. Slow deceleration control is control that uses a vehicle behavior of deceleration to make the driver aware of an approach of an obstacle and to urge attention calling, and is control that is different from contact avoidance control for avoiding contact with an obstacle (however, there may be cases of resulting in avoiding contact with the obstacle). The slow deceleration control is executed, for example, when the distracted driving determiner 140 determines that the driver is performing the distracted driving, and the contact margin value satisfies operating conditions for the slow deceleration control.

The braking controller 152 may stop the slow deceleration control when the driving state detector 130 detects an accelerator operation of the driver (an operation of the accelerator pedal 84) equal to or greater than a predetermined value (for example, a predetermined amount) during the slow deceleration control. In this manner, by determining an intention of the driver through the accelerator operation, more appropriate override control (switching to a manual operation by the driver) can be executed for slow deceleration control. The predetermined value (predetermined amount) may be changed on the basis of an operation speed of the accelerator operation of the driver. For example, the braking controller 152 sets a predetermined value to be smaller when the operation speed is equal to or more than a predetermined speed than when the operation speed is less than the predetermined speed (on the contrary, when the operation speed is less than a predetermined speed, the predetermined value is set to be larger than when the operation speed is equal to or more than a predetermined speed. For example, the braking controller 152 may change the predetermined value according to the target deceleration, and may set the predetermined value to be larger as the target deceleration becomes larger. As a result, a more appropriate override determination can be realized depending on a driving state of the driver and the surrounding situation of the host vehicle M.

The braking controller 152 performs emergency braking control as contact avoidance braking control to avoid contact between the host vehicle M and an obstacle. The contact avoidance braking control is braking control (deceleration control) for avoiding contact when it is determined that there is a possibility that the host vehicle M will come into contact with an obstacle based on the surrounding situation recognized by the recognizer 110. The contact avoidance braking control includes, for example, collision mitigation brake system (CMBS) control that supports contact avoidance or damage mitigation. The contact avoidance braking control may be executed, for example, after slow deceleration control, and furthermore may be executed when a contact margin value satisfies the operating conditions for contact avoidance braking control.

The steering controller 154 controls the steering of the host vehicle M. The steering controller 154 includes, for example, centering steering control and contact avoidance steering control. Centering steering control is steering control (centering steering control) that moves the host vehicle M toward a center of the traveling lane when the recognizer 110 determines that an obstacle is present in front of the host vehicle M. This steering control is not control for avoiding contact with an obstacle, but control that uses a vehicle behavior of laterally moving near the center to make the driver aware of the obstacle ahead and to urge attention calling (however, there may be cases of resulting in avoiding contact with the obstacle). This steering control allows the driver to be aware of the obstacle ahead at an early stage, and contributes to driving of the driver to avoid contact. The centering steering control may be executed when the distracted driving determiner 140 determines that the driver is performing the distracted driving, and further may also be executed when the contact margin value satisfies operating conditions of steering control. The slow deceleration control and the centering steering control described above may be executed separately or executed simultaneously at the same timing (for example, an attention calling control stage).

The steering controller 154 performs steering control of the host vehicle M to avoid contact between the host vehicle M and the obstacle as the contact avoidance steering control. In the contact avoidance steering control, the host vehicle M is moved to a space where it does not come into contact with an obstacle within a range not departing from the same lane, without depending on the steering operation of the driver, when it is possible to avoid the contact within the traveling lane of the host vehicle M. In the contact avoidance steering control, the steering control of the host vehicle M may also be performed such that, after the host vehicle M crosses over a division line that divides the traveling lane and performs an avoidance operation to avoid contact with the obstacle using the steering operation of the driver, a behavior of the host vehicle M after the avoidance operation is stabilized. The contact avoidance steering control may be, for example, executed after centering steering control and may be executed when the contact margin value satisfies the operating conditions for the contact avoidance steering control.

The vehicle controller 150 may perform control other than the vehicle control described above. For example, the vehicle controller 150 may perform steering control to maintain the host vehicle M within the traveling lane as lane keeping assistance system (LKAS) control. In this case, the vehicle controller 150 supports the steering operation of the driver by, for example, controlling the steering device 220 so that the host vehicle M does not deviate from the traveling lane.

The HMI controller 160 notifies occupants (including the driver) of predetermined information through the HMI 30. The predetermined information includes, for example, information related to traveling of the host vehicle M, such as information regarding the state of the host vehicle M and information regarding driving control. The information regarding the state of the host vehicle M includes, for example, the speed, an engine rotation speed, a shift position, and the like of the host vehicle M. The information regarding driving control includes, for example, a type of driving control being executed (for example, gradual deceleration, centering steering control, contact avoidance braking control, contact avoidance steering control), a reason for operating driving control, a status of driving control, and the like. The information regarding driving control may include information regarding an attention calling and a contact caution warning with respect to the driver. The predetermined information may include information regarding a current position, a destination, and a remaining fuel level of the host vehicle M, and the like, and may include information not related to travel control of the host vehicle M, such as television programs and content (for example, movies) stored on a storage medium such as a DVD.

For example, the HMI controller 160 may generate an image including the predetermined information described above and display the generated image on the display 32 of the HMI 30, or may generate a sound indicating predetermined information and output the generated sound through the speaker 34 of the HMI 30. A timing at which the sound is output include, for example, a timing at which driving control is started or stopped, a timing at which images to be displayed are switched, a timing at which the host vehicle M enters a predetermined state, and the like. The HMI controller 160 may output the information received by the HMI 30 to the vehicle controller 150 or the like.

### Vehicle Controller

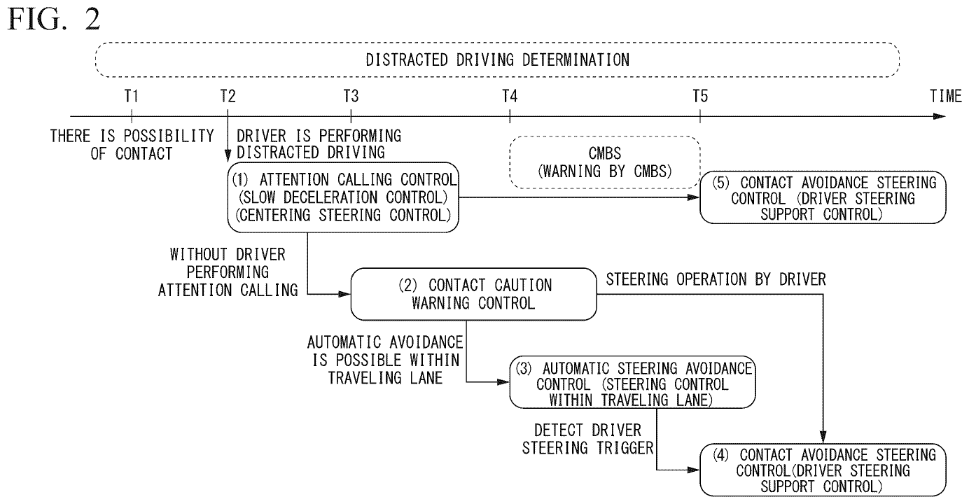

Next, content of vehicle control by the vehicle controller 150 of the embodiment will be specifically described. FIG. 2 is a diagram for describing the content of vehicle control according to the embodiment. The example of FIG. 2 shows the content of vehicle control when it is determined that there is a possibility of contact based on the contact margin time TTC, which is an example of the contact margin value. In the example of FIG. 2, it is assumed that a time T1 is the earliest, and times T2, T3, T4, and T5 are later in that order.

First, it is assumed that the contact possibility determiner 120 determines that there is a possibility of contact between the host vehicle M and the obstacle at the time T1. The distracted driving determiner 140 may continue to determine whether the driver is performing the distracted driving from a time prior to the time T1. Details of distracted driving determination will be described below. When it is determined that there is a possibility of contact, the vehicle controller 150 performs the attention calling control ((1) of FIG. 2) for urging the driver to pay attention to the surroundings (especially in a traveling direction) on the basis of the contact margin time TTC and a result of determination by the distracted driving determiner 140.

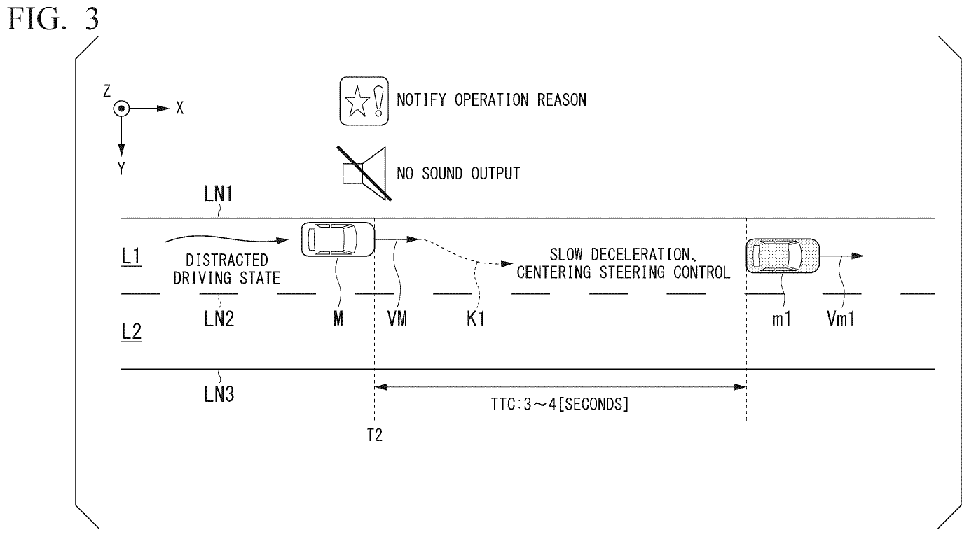

FIG. 3 is a diagram for describing content of the attention calling control. The example in FIG. 3 shows lanes L1 and L2 that allow the vehicle to travel in the same direction (an X-axis direction in FIG. 3). The lane L1 is divided by road division lines LN1 and LN2, and the lane L2 is partitioned by road division lines LN2 and LN3. In the example of FIG. 3, it is assumed that the host vehicle M is traveling in the lane L1 at a speed VM, and another vehicle (a preceding vehicle) m1 is present in front of the host vehicle M and is traveling in the lane L1 at a speed Vm1. The other vehicle m1 is an example of the “obstacle.”

In the example of FIG. 3, the vehicle controller 150 performs the attention calling control when it reaches a time T2 at which the contact margin time TTC based on the relative position and relative speed between the host vehicle M and the other vehicle m1 is equal to or greater than a first predetermined value (a predetermined period of time), and it is determined that the driver is performing the distracted driving. The time T2 is, for example, a time at which the contact margin time TTC is approximately 3 to 4 [seconds].

The attention calling control includes, for example, at least one of slow deceleration control and centering steering control. The slow deceleration control executed in the attention calling control is control in a first deceleration state. The braking controller 152 sets a target deceleration (a first target deceleration) so that a load (vertical G) of a first upper limit deceleration (approximately 0.1 [G]) is applied to the driver in the traveling direction (vertical direction). In the attention calling control (first deceleration state), the braking controller 152 may first perform slow deceleration control at a first deceleration level (for example, a vertical G of 0.05 [G]), and then perform deceleration control at a second deceleration level (for example, a vertical G of 0.1 [G]) that is larger than the first deceleration level. By controlling deceleration to increase the deceleration level in stages in this manner, it is possible to reduce a load on an occupant such as the driver at the time of starting execution of the slow deceleration control, and to prevent the occupant from being surprised by the slow deceleration control.

In the attention calling control shown in FIG. 3, the steering controller 154 performs centering steering control such that a reference point such as the center of gravity or a center of the host vehicle M is positioned in the center of the traveling lane (the lane L1). In the example of FIG. 3, the vehicle controller 150 generates a future target trajectory K1 of the host vehicle M corresponding to the slow deceleration control and the centering steering control, and controls the steering and speed of the host vehicle M so that the host vehicle M travels along the target trajectory K1.

At the time T2, the HMI controller 160 may generate an image showing a reason for operating the attention calling control (the slow deceleration control, the centering steering control) to the driver, and display the generated image on the display 32 to notify the driver of it. However, in this case, sound may not be output. This makes it possible to urge attention calling by simply informing the driver of an approach to an obstacle, and to urge the driver to perform an early avoidance operation.

Returning to FIG. 2, when it is a time T3 at which the contact margin time TTC (contact margin value) becomes less than a predetermined value (a predetermined period of time) in a state in which the driver does not perform attention calling (override control) of the surroundings even if the attention calling control described above is performed, and it is determined that the driver is performing the distracted driving, contact caution warning control ((2) in FIG. 2) is performed. The time T3 is, for example, a time when the contact margin time TTC is about 2 [seconds].

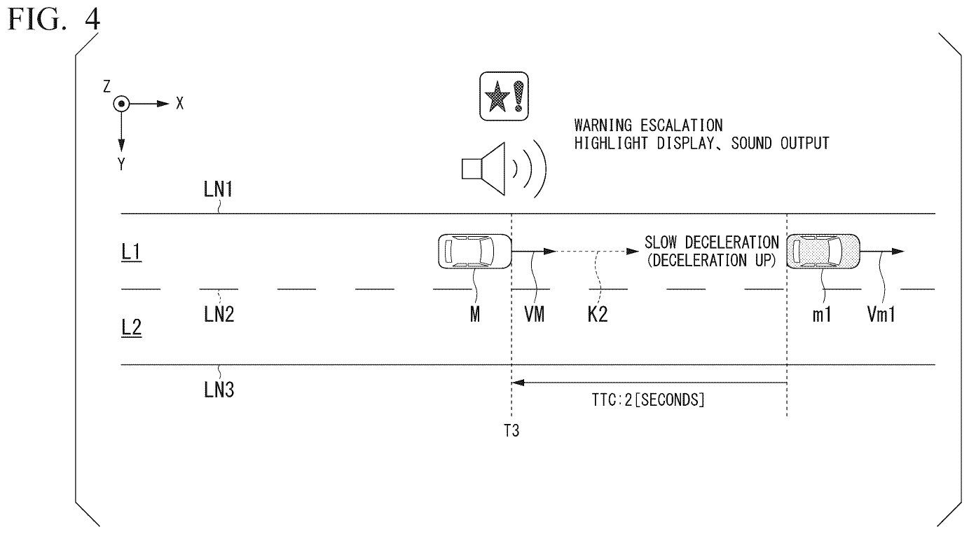

FIG. 4 is a diagram for describing content of the contact caution warning control. FIG. 4 shows a scene where the contact margin time TTC becomes 2 [seconds] in a situation where the driver does not operate the accelerator from the situation shown in FIG. 3. In the contact caution warning control stage, a slow deceleration controller 142A sets a target deceleration (a second target deceleration), executes the slow deceleration control according to the set second target deceleration, generates a target trajectory K2, and performs control so that the host vehicle M travels along the generated target trajectory K2. The slow deceleration control executed in the contact caution warning control is control in the second deceleration state. In the second deceleration state, the braking controller 152 sets a target deceleration (a second target deceleration) so that a load (vertical G) is applied to the driver in the traveling direction (vertical direction), which is equal to or less than the second upper limit deceleration (approximately 0.2 [G]) and is greater than the first upper limit deceleration. As a result, it is possible to make the driver aware of an approach of the host vehicle M to the other vehicle m1 more clearly. In this manner, since deceleration control is performed while increasing the deceleration as necessary, more time for making the other vehicle m1 aware of the approach can be created, and the driver can avoid contact with the other vehicle m1 with plenty of time.

During the contact caution warning control, in addition to (or in place of) the slow deceleration control, the centering steering control described above may also be executed. During the contact caution warning control, the HMI controller 160 may highlight an image of attention calling information displayed on the display 32, or may also execute control (warning escalation control) to output a warning through the speaker 34. As a result, it is possible to strongly notify the driver through images and sounds that there is a high possibility of contact while decelerating the vehicle, and to clearly urge the driver to take the attention calling and the contact avoidance control.

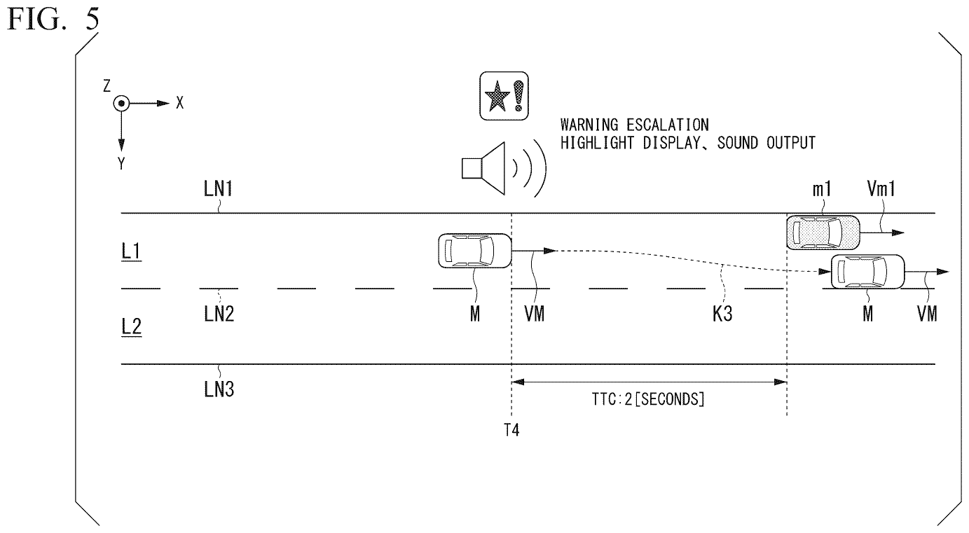

Returning to FIG. 2, after executing the contact caution warning control, at a time T4 when the vehicle controller 150 determines that automatic avoidance is possible within the traveling lane based on the surrounding situation recognized by the recognizer 110, the steering controller 154 executes automatic steering avoidance control ((3) shown in FIG. 2). FIG. 5 is a diagram for describing content of the automatic steering avoidance control. In the example of FIG. 5, for example, control is performed when the driver has not operated the accelerator after executing the contact caution warning control. In this case, the steering controller 154 performs steering control on the basis of a positional relationship between an area of the traveling lane and the other vehicle m1, generates a target trajectory K3 for traveling in an avoidance space when the avoidance space is present in the traveling lane, and executes the steering control so that the host vehicle M travels along the generated target trajectory K3. The steering controller 154 may perform acceleration or deceleration control in addition to the steering control. During the automatic steering avoidance control, the HMI controller 160 may continue to perform the warning escalation control described above. As a result, when steering avoidance is possible under highly safe control, more appropriate vehicle control can be achieved by executing automatic steering control.

At this timing, the vehicle controller 150 may execute CMBS control using the contact avoidance braking controller 152B in parallel. When the CMBS control is executed, the automatic steering avoidance control described above and contact avoidance steering control to be described below do not need to be executed.

Returning to FIG. 2, at a time T5 when the driver operates the steering wheel 82 (detects a driver steering trigger) and performs a steering operation in a direction of avoiding the other vehicle m1, a contact avoidance steering controller 154B performs the contact avoidance steering control so as not to further deviate from an adjacent lane (a lane L2) adjacent to the traveling lane (the lane L1) ((4) in FIG. 2). The driver steering trigger means, for example, that a steering operation amount of the driver to avoid the other vehicle m1 becomes equal to or greater than a predetermined amount. The contact avoidance steering control may be executed after the automatic steering avoidance control, or may be executed after the contact caution warning control.

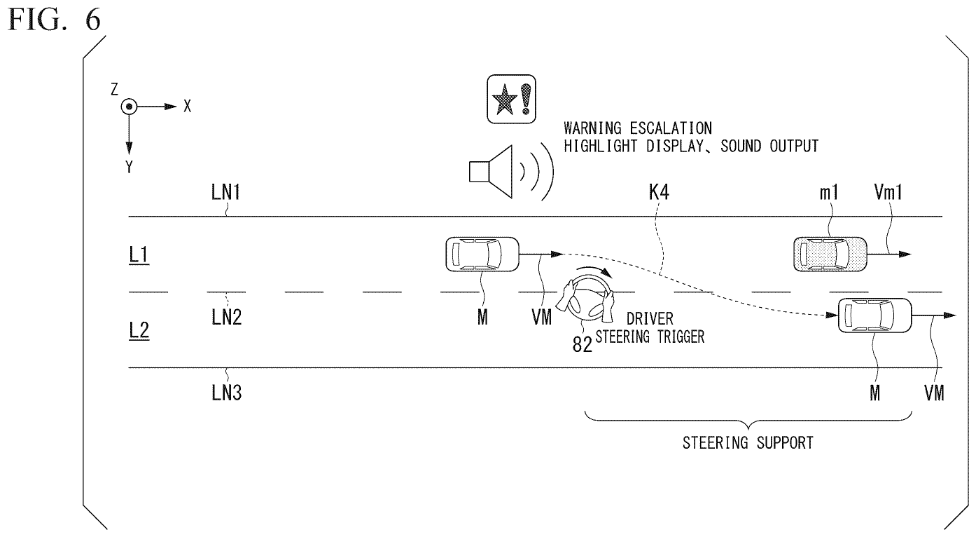

FIG. 6 is a diagram for describing steering control after the driver steering trigger. In the example of FIG. 6, when there is no space in the host lane L1 for the host vehicle M to avoid contact with the other vehicle m1 and the driver steering trigger is detected, the steering controller 154 allows the host vehicle M to move from the lane L1 to the adjacent lane L2, and controls the steering of the host vehicle M so as not to further deviate from the adjacent lane L2. For example, a target trajectory K4 for changing lanes to the lane L2 is generated, and steering support is performed so that the position of the host vehicle M approaches the target trajectory K4 through a steering operation by the driver. During the contact avoidance steering control, the HMI controller 160 may continue to execute the warning escalation control described above. As a result, even when emergency avoidance steering is performed by the steering operation of the driver, more appropriate vehicle control can be achieved.

When the contact margin time TTC becomes close to a limit value after the attention calling control shown in (1) of FIG. 2 and the driver performs a steering operation, the vehicle controller 150 executes the contact avoidance steering control (driver steering support control) to prevent the vehicle from further crossing the adjacent lane ((5) in FIG. 2), similar to the control in (4) in FIG. 2. In this case, the HMI controller 160 may perform notification control such as a notification or a warning that the contact avoidance steering control is operated.

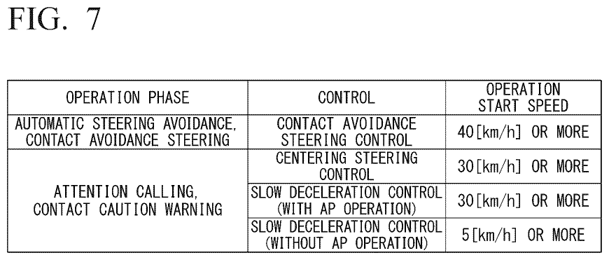

In each operation phase of attention calling, contact caution warning, automatic steering avoidance, and contact avoidance steering shown in FIG. 2, a condition regarding the speed of the host vehicle M may be added to determination conditions for an operation. FIG. 7 is a diagram for describing a speed condition of the host vehicle M that starts control for each operation phase. For example, in the contact avoidance steering control in automatic steering avoidance or contact avoidance steering (steering support), one operation start condition is that the speed VM of the host vehicle M is 40 [km/h] or more. Since this control is control after attention calling, if the contact margin time TTC is approximately 2 [seconds], contact avoidance can be sufficiently achieved by a brake operation of the driver. The centering steering control in attention calling and contact caution warning is controlled so that it is executed when the speed VM of the host vehicle M is 30 [km/h] or more. Regarding the slow deceleration control in the caution alert and contact caution warning, if there is an accelerator operation (AP operation), control is performed so that it is executed when the speed VM of the host vehicle M is 30 [km/h] or more. This speed is below a steering avoidance limit speed and within a range where there is a performance margin for CMBS control, more appropriate operation control can be achieved by setting this condition. When there is no AP operation, the control is performed so that it is executed when the speed VM of the host vehicle M is 5 [km/h] or more. That is, the speed is set to be lower when the AP operation of the driver is not detected than when the AP operation is detected. By relaxing the conditions for starting the slow deceleration control in situations where there is no AP operation, the slow deceleration control can be executed in a variety of situations, including a state of distracted driving in a traffic jam, so that contact between the host vehicle M and the other vehicle m1 can be avoided more safely.

### Distracted Driving Determiner

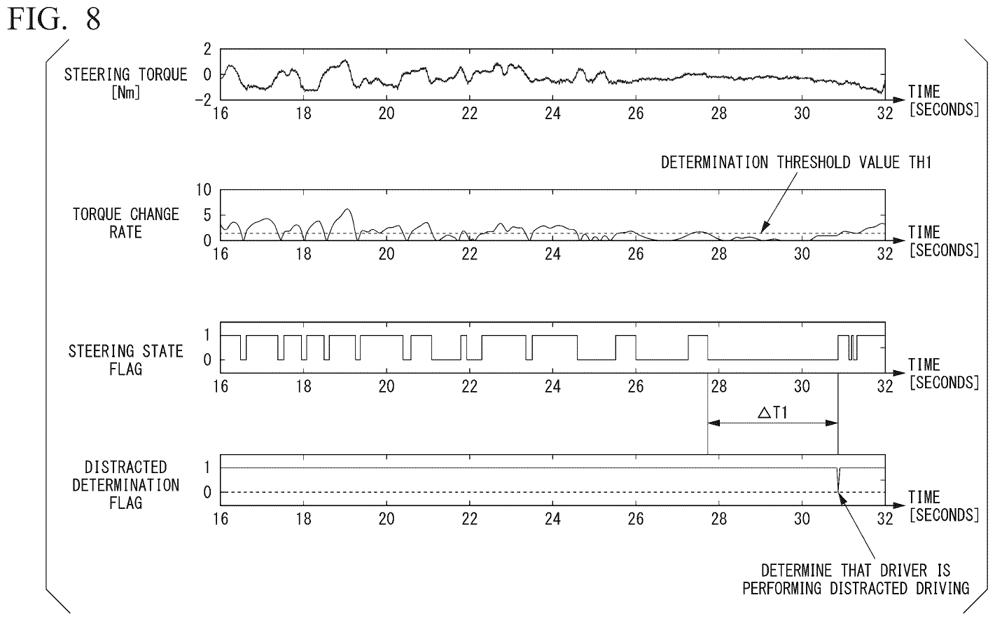

Next, determination content of the distracted driving by the distracted driving determiner 140 will be described. FIG. 8 is a diagram for describing the determination content of the distracted driving. In the example of FIG. 8, the horizontal axis indicates time [seconds], and the vertical axis indicates a steering torque [Nm] of the host vehicle M, a torque change rate, a steering state flag, and a distracted determination flag. In the example of FIG. 8, the steering status flag indicates whether the driver is performing a steering operation using a flag, and it is “1” indicating that a steering operation is being performed when the torque change rate is equal to or greater than the determination threshold value TH1, and it is “0” indicating that a steering operation is not being performed when the torque change rate is less than the determination threshold value TH1. The distracted determination flag indicates whether the driver is performing the distracted driving, and it is “0” when it is determined that the driver is performing the distracted driving, and it is “1” when it is determined that the driver is not performing the distracted driving.

The distracted driving determiner 140 determines that the driver is performing the distracted driving, for example, when a state in which an operation amount of the driving operation is less than the determination threshold value continues for a predetermined period of time or more. Specifically, as shown in FIG. 8, the distracted driving determiner 140 calculates the torque change rate based on the steering torque of the driver obtained from the SW sensor 82A, and determines whether the calculated torque change rate is equal to or greater than the determination threshold value TH1. The distracted driving determiner 140 determines that the driver is performing distracted driving when a state in which the torque change rate is less than the determination threshold value TH1 continues for a predetermined period of time ΔT1 or more. For example, when the attention calling control or contact caution warning control is performed on a condition that the driver is performing distracted driving, since the control described above will also be executed frequently if it switches frequently whether the driver is performing distracted driving, it is possible to prevent the driver from feeling that control switching is troublesome by adding continuation of the state for a predetermined period of time ΔT1 or more to the determination conditions of distracted driving.

### Time Setter

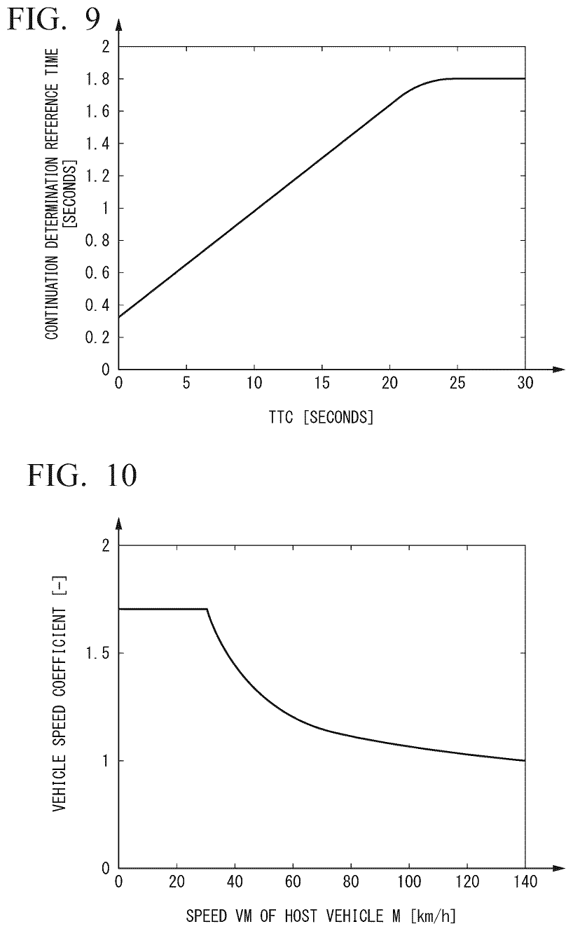

Next, setting content of the predetermined period of time by the time setter 142 will be described. For example, the time setter 142 sets the predetermined period of time ΔT1 by multiplying a continuation determination reference time, which is set on the basis of the contact margin time TTC between the host vehicle M and an obstacle (for example, another vehicle m1), and a vehicle speed coefficient, which is set on the basis of the speed VM of the host vehicle M. The continuation determination reference time is, for example, a time (a reference time) during which it can be determined that the host vehicle M can travel without coming into contact with the obstacle in a state in which there is no driving operation by the driver (the amount of operation is less than a threshold value). FIG. 9 is a diagram for describing a relationship between the contact margin time TTC and the continuation determination reference time. In the example of FIG. 9, the horizontal axis indicates the contact margin time TTC [seconds], and the vertical axis indicates the continuation determination reference time [seconds]. In the example of FIG. 9, as the contact margin time TTC decreases, the continuation determination reference time [seconds] is set to be smaller.

In the example in FIG. 9, when the contact margin time TTC is 0 (zero), the continuation determination reference time is set to a certain value (for example, about 0.3 [seconds]), and the continuation determination reference time that increases linearly (becomes longer) is set as the contact margin time TTC is increased from the set value. An increasing trend is not limited to the example described above, and may increase non-linearly (curvilinearly or stepwise). Regarding the continuation determination reference time, when the contact margin time TTC is equal to or greater than a predetermined value, an amount of adjustment corresponding to the contact margin time TTC may be suppressed. Suppressing the amount of adjustment may include reducing an amount of time correction caused by the contact margin time TTC, or not performing more correction than the current amount (keeping the amount of adjustment constant). In the example of FIG. 9, the continuation determination reference time is kept constant (for example, about 1.8 [seconds]) after a time when there is sufficient time for the host vehicle M and the other vehicle m1 to come into contact with each other (for example, about 24 [seconds]). In this manner, by setting the continuation determination reference time on the basis of the contact margin time TTC, if the driver is in danger, since the predetermined period of time ΔT1 is set to be shorter, distracted driving can be determined in a short time. When there is little danger, distracted driving can be determined over a certain period of time, thereby increasing an accuracy of the determination.

FIG. 10 is a diagram for describing a relationship between the speed VM of the host vehicle M and the vehicle speed coefficient. In the example of FIG. 10, the horizontal axis indicates the speed VM [km/h] of the host vehicle M, and the vertical axis indicates the vehicle speed coefficient. In places where the speed VM of the host vehicle M is low, a speed at which the traffic situation changes is also slow, and it is considered that contact between the host vehicle M and the other vehicle m1 can be sufficiently avoided by CMBS control or the like. For this reason, in the example of FIG. 10, the coefficient is increased as the speed VM decreases (as it becomes smaller), so that the predetermined period of time ΔT1 is made longer. However, in reality, there are some cases of collisions caused by drivers looking away during traffic jams, and the like. For this reason, when the speed VM is less than a predetermined speed, the amount of adjustment (an amount of increase) of the vehicle speed coefficient corresponding to the speed VM may be suppressed. Suppressing the amount of adjustment may include reducing the amount of correction of the vehicle speed coefficient caused by the speed VM, or not performing correction more than the current amount (keeping the amount of adjustment constant). In the example of FIG. 10, when the speed VM is equal to or lower than a predetermined speed (for example, around 30 [km/h]), the coefficient is not increased any further and remains constant. This can reduce the number of collisions caused by looking away during traffic jams, and the like. In the example of FIG. 10, the vehicle speed coefficient is set to nonlinearly (on a curve) increases (becomes larger) as the speed V decreases (becomes smaller) until the speed VM becomes around 30 [km/h] or less. However, it may be set to increase linearly or stepwise.

The information shown in FIGS. 9 and 10 may be stored in the storage 170, for example. When the predetermined period of time ΔT1 is set, the time setter 142 refers to the storage 170, acquires the continuation determination reference time and the vehicle speed coefficient on the basis of the current contact margin time TTC and the speed VM of the host vehicle M from the correspondence information shown in FIGS. 9 and 10, and sets the predetermined period of time ΔT1 to be variable. As a result, the distracted driving determiner 140 can perform distracted driving determination at an appropriate time, and can perform more appropriate vehicle control according to the surrounding situation of the vehicle based on a result of the determination.

The time setter 142 may set a predetermined period of time depending on driving content of the driver and an operation at a time of traveling. For example, before entering an inattentiveness state or a distracted driving state, there is a preparatory operation by the driver to stabilize a state of the host vehicle M. The preparatory operation is, for example, a driving operation that leaves a space between the host vehicle M and an obstacle (vehicle in front), or moves the host vehicle M to a direction or position where it is difficult to deviate from a lane (for example, a position in a center of the lane). Therefore, when the time setter 142 recognizes the preparation operation described above on the basis of a result of recognition by the recognizer 110, the time setter 142 may set the predetermined period of time ΔT1 on the basis of the speed VM of the host vehicle M. For example, when a safety area is secured around the host vehicle M by a preparatory operation while the host vehicle M is traveling at a speed of 60 to 70 km/h, a predicted time during which the host vehicle M can remain within the lane without changing steering is approximately 5 [seconds]. Therefore, the time setter 142 sets the predetermined period of time ΔT1 to be equal to or less than the time (approximately 5 [seconds]) corresponding to the safety area secured in the preparatory operation. This makes it possible to determine distracted driving within an area that is predicted to be safe.

During normal driving, for example, when the driver operates in-vehicle equipment such as the navigation device 50 or an acoustic device (not shown), there is a certain amount of allowable time during which the driver looks away. The allowable time in this case is approximately 2 [seconds]. Therefore, the time setter 142 may set the predetermined period of time ΔT1 to be equal to or longer than the allowable time (approximately 2 [seconds]) corresponding to the operation of the in-vehicle equipment of the host vehicle M. As a result, it is possible to prevent the driver from being determined to perform distracted driving in a generally allowable operation time of the in-vehicle equipment, and to detect a distracted driving state that is likely to lead to an accident.

### Processing Flow

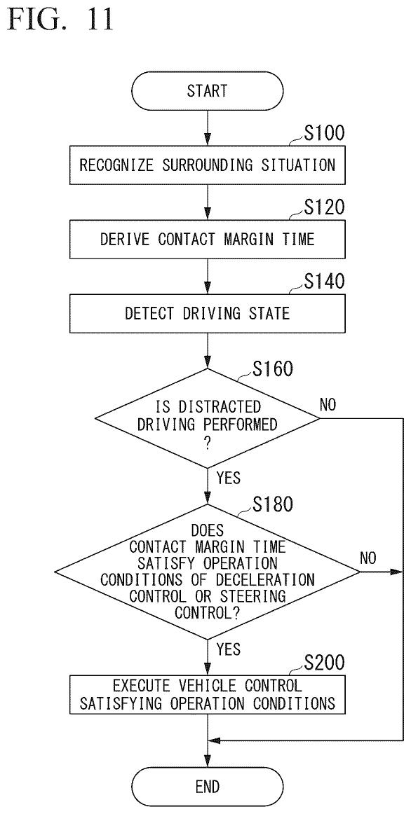

FIG. 11 is a flowchart which shows an example of processing executed by the driving support device 100 in the embodiment. In the example of FIG. 11, among the processing executed by the driving support device 100, vehicle control processing including particularly distracted driving determination will be described.

In the example of FIG. 11, the recognizer 110 recognizes the surrounding situation of the host vehicle M (step S100). Next, the contact possibility determiner 120 derives the contact margin time TTC between the host vehicle M and the obstacle on the basis of the recognized surrounding situation (step S120). Next, the driving state detector 130 detects a driving state of the driver of the host vehicle M (step S140). Next, the distracted driving determiner 140 determines whether the driver performs distracted driving on the basis of a result of the driving state detection by the driving state detector 130 (step S160). When it is determined that the driver performs distracted driving, the vehicle controller 150 determines whether the contact margin time TTC satisfies operating conditions for deceleration control or steering control (step $180). When it is determined that the contact margin time TTC satisfies the operating conditions for deceleration control or steering control, vehicle control that satisfies the operating conditions is executed (step S200). This vehicle control includes, for example, attention calling control, contact caution warning control, automatic steering avoidance control, contact avoidance steering control, and the like. As a result, processing of this flowchart ends. When it is determined in the processing of step S160 that the driver does not perform distracted driving, or when it is determined in the processing of step S180 that the contact margin time TTC does not satisfy the operating conditions for deceleration control or steering control, the processing of this flowchart ends.

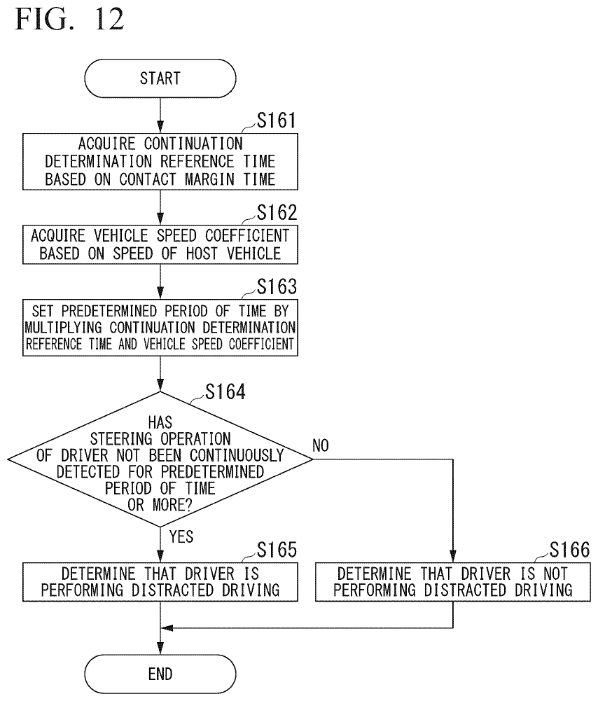

FIG. 12 is a flowchart which shows an example of distracted determination processing. The processing shown in FIG. 12 embodies an example of the processing in step S160 described above. In the example of FIG. 12, the time setter 142 acquires the continuation determination reference time based on the contact margin time TTC (step S161). Next, the time setter 142 acquires the vehicle speed coefficient based on the speed VM of the host vehicle M (step S162). Next, the time setter 142 multiplies the continuation reference determination time and the vehicle speed coefficient to set the predetermined period of time ΔT1 (step S163).

Next, the distracted driving determiner 140 determines whether a steering operation of the driver has not been continuously detected for a predetermined period of time ΔT1 or more (step S164). When it is determined that the steering operation has not been continuously detected for the predetermined period of time ΔT1 or more, the distracted driving determiner 140 determines that the driver is performing distracted driving (step S165). When it is not determined that the steering operation has not been detected for a predetermined period of time or more (that is, the steering operation of the driver has been detected), it is determined that the driver is not performing distracted driving (step S166). As a result, the processing of this flowchart ends.

According to the embodiment as described above, the vehicle control device includes the recognizer 110 that recognizes the surrounding situation of the host vehicle M, the driving state detector 130 that detects the driving state of the occupant of the host vehicle M, and the distracted driving determiner (an example of a determiner) 140 that determines distracted driving of the occupant on the basis of a result of the detection by the driving state detector 130, in which the distracted driving determiner 140 determines that the occupant is performing distracted driving when the steering operation of the occupant is not detected by the driving state detector 130 for a predetermined period of time or more, and the predetermined period of time is set on the basis of the contact margin time between surrounding obstacles of the host vehicle and the host vehicle, and the speed of the host vehicle, and thereby the driver can perform a more appropriate distracted driving determination according to the surrounding situation of the host vehicle M. Therefore, the occupant can perform more appropriate vehicle control depending on the surrounding situation of the host vehicle M.

Specifically, according to the embodiment, for example, by determining that the driver is performing distracted driving when a steering torque input is not detected for a predetermined period of time and changing the predetermined period of time depending on a contact margin time TTC with an obstacle (for example, a preceding vehicle) and the speed VM of the host vehicle M, it is possible to perform a more appropriate distracted driving determination according to a traveling situation and the surrounding situation of the host vehicle M.

For example, as a distance to the obstacle ahead becomes shorter, a possibility of contact increases. For this reason, in the embodiment, by setting the margin time to be shorter as the distance to the obstacle becomes shorter, distracted driving can be detected at an early stage, and vehicle control (driving support) can be performed so that the driver notices the obstacle ahead or avoids contact with it. Since it may not be possible to detect distracted driving when the margin time with the obstacle is too long, by keeping a margin period constant when the distance with the obstacle is greater than a predetermined value and making it possible to appropriately determine distracted driving in the embodiment, it is possible to detect distracted driving due to inattentiveness or the like while reducing excessive determinations.

For example, as the speed VM of the host vehicle M increases, a speed difference with the obstacle ahead is likely to occur, and time for approaching the obstacle ahead becomes shorter due to the speed difference. In the embodiment, distracted driving can be detected at an early stage by setting a reference time for distracted determination to be shorter as the speed of the host vehicle M increases. Therefore, it is possible to perform vehicle control to make the driver aware of the obstacle ahead at an early stage, or to perform driving support to avoid contact. Since inattentiveness or the like of the driver tends to increase as the speed decreases, in the embodiment, by keeping a change in the predetermined period of time due to the speed constant and not making the predetermined period of time longer than necessary, it is possible to achieve more appropriate vehicle control by balancing an occurrence of unnecessary distracted driving determination at a low speed with the detection of distracted driving due to inattentiveness or the like.

### Modified Example

In the embodiment described above, the slow deceleration control and the centering steering control in the attention calling control and the contact caution warning control are performed using a case where it is determined that the driver is performing distracted driving as one of the operating conditions. The slow deceleration control and the centering steering control may be selected and executed depending on whether the driver is performing distracted driving. For example, the vehicle controller 150 may perform the slow deceleration control and the centering steering control in the attention calling control and the contact caution warning control when it is determined that the driver is performing distracted driving, and may perform any one of the slow deceleration control and the centering steering control when it is determined that the driver is not performing distracted driving. The vehicle controller 150 may not execute the centering steering control (for example, when the vehicle is caused to travel along road division lines), or may execute the slow deceleration control when the host vehicle M moves in a direction approaching the other vehicle m1 by performing the centering steering control. Furthermore, since the vehicle controller 150 cannot perform the centering steering control when division lines of the traveling lane cannot be recognized, the vehicle controller 150 may perform the slow deceleration control or the centering steering control without determining whether the driver is performing distracted driving in the embodiment described above.

In the distracted driving determiner 140, the determination threshold value TH1 regarding distracted driving of the driver may be set variably depending on, for example, a road situation on which the host vehicle M is traveling (for example, a curved road, a straight road, or the like), and may be set variably depending on a vehicle type of the host vehicle M (steering characteristics for each vehicle type) or the like.

In the embodiment described above, the obstacle is not limited to a preceding vehicle, but may be another vehicle approaching the host vehicle M. The obstacle may be pedestrians, bicycles, or other objects (not necessarily be a moving object). Numerical values shown in the embodiment described above are merely examples, and may be adjusted as appropriate according to a road situation (a shape, the number of lanes, or a road type), a driving situation of the driver (a level of distractedness), a vehicle situation (a speed, a vehicle type, a shape, or the number of passengers), and the like.

The embodiment described above can be expressed as follows.

A vehicle control device including a storage medium that stores computer-readable instructions and a processor connected to the storage medium, the processor executing the computer-readable instructions to: recognize a surrounding situation of a vehicle; detect a driving state of an occupant of the vehicle; and determine that the occupant is performing distracted driving when a steering operation of the occupant is not detected for a predetermined period of time or more on the basis of a result of detection, in which the predetermined period of time is set on the basis of a contact margin time between an obstacle near the vehicle and the vehicle, and a speed of the vehicle.

Although a mode for carrying out the present invention has been described above using the embodiment, the present invention is not limited to the embodiment, and various modifications and substitutions can be made within a range not departing from the gist of the present invention.

What is claimed is:

1. A vehicle control device comprising:
a recognizer configured to recognize a surrounding situation of a vehicle;
a driving state detector configured to detect a driving state of an occupant of the vehicle, and
a determiner configured to determine distracted driving of the occupant on the basis of a result of detection by the driving state detector,
wherein the determiner determines that the occupant is performing distracted driving when a steering operation of the occupant is not detected by the driving state detector for a predetermined period of time or more, and
the predetermined period of time is set on the basis of a contact margin time between an obstacle near the vehicle and the vehicle, and a speed of the vehicle.

2. The vehicle control device according to claim 1,
wherein the predetermined period of time is set to be longer as the contact margin time increases.

3. The vehicle control device according to claim 2,
wherein, when the contact margin time is equal to or greater than a predetermined value, the predetermined period of time is set so that an amount of adjustment of time corresponding to the contact margin time is suppressed.

4. The vehicle control device according to claim 1,
wherein the predetermined period of time is set to be longer as the speed of the vehicle decreases.

5. The vehicle control device according to claim 4,
wherein, when the speed of the vehicle is less than a predetermined speed, the predetermined period of time is set so that an amount of adjustment of time corresponding to the speed of the vehicle is suppressed.

6. The vehicle control device according to claim 1,
wherein, when there is no driving operation of the occupant, which is set on the basis of the contact margin time, the predetermined period of time is set by multiplying a reference time at which a vehicle can be determined to be able to travel without contacting the obstacle and a coefficient set on the basis of the speed of the vehicle.

7. The vehicle control device according to claim 1, further comprising:
a vehicle controller configured to control one or both of steering and acceleration or deceleration of the vehicle on the basis of the contact margin time and perform attention calling to the occupant when the determiner determines that the occupant is performing distracted driving.

8. A vehicle control method comprising:
by a computer,
recognizing a surrounding situation of a vehicle;
detecting a driving state of an occupant of the vehicle; and
determining that the occupant is performing distracted driving when a steering operation of the occupant is not detected for a predetermined period of time or more on the basis of a result of detection,
wherein the predetermined period of time is set on the basis of a contact margin time between an obstacle near the vehicle and the vehicle, and a speed of the vehicle.

9. A computer-readable non-temporary storage medium that has stored a program causing a computer to execute
recognizing a surrounding situation of a vehicle;
detecting a driving state of an occupant of the vehicle; and
determining that the occupant is performing distracted driving when a steering operation of the occupant is not detected for a predetermined period of time or more on the basis of a result of detection,
wherein the predetermined period of time is set on the basis of a contact margin time between an obstacle near the vehicle and the vehicle, and a speed of the vehicle.
